(19) United States
(12) Patent Application Publication
(10) Pub. No.: US 2007/0200708 A1
(43) Pub. Date: Aug. 30, 2007

(54) Loop antenna and RFID tag

(76) Inventors: Kosuke Hayama, Kyoto (JP); Keisuke Saito, Kyoto (JP)

Correspondence Address: DICKSTEIN SHAPIRO LLP, 1825 EYE STREET NW, Washington, DC, 20006-5403, US

(21) Appl. No.: 11/588,272

(22) Filed: Oct. 27, 2006

(30) Foreign Application Priority Data
Feb. 24, 2006 (JP) P2006-047868

(51) Int. Cl. G08B 13/14; H01Q 7/00

(52) U.S. Cl. 340/572.7; 343/866

(57) ABSTRACT

A loop antenna 1 for an RFID tag 100 includes an annular line member 10 that includes meandering parts 13 and 14 disposed on a dielectric substrate 2, and power feeding parts 11 that are provided on the line member 10. The annular line member 10 includes the meandering parts 13 and 14 at portions except for the vicinity of positions corresponding to loops of a standing wave occurring in the loop antenna 1.

### TECHNICAL FIELD

The present disclosure relates to a loop antenna used in an RFID (Radio Frequency Identification) tag.

### RELATED ART

In the related art, as an antenna of RFID tag, an antenna disposed in a loop shape along sides of a substrate of an RFID tag, a so-called loop antenna has been proposed (for example, see Patent Document 1: Japanese Patent Unexamined Publication No. 2006-031473 (page 1 and FIG. 1)). In the loop antenna, when an entire path length of the line member is formed to be equal to a wavelength of an electric wave used to read and write information on the RFID tag, the above loop antenna operates in the same way as the structure where two half-wavelength dipole antennas are arranged in parallel. As a result, the loop antenna can be used as a directional antenna in a loop axis direction. Therefore, the loop antenna obtains a higher gain than the half-wavelength dipole antenna.

However, as the size of the RFID tag has decreased recently, the size of the loop antenna also needs to decrease.

For example, RFID tags are used as labels of baggage of the distribution industry in America where systems using RFID tags used in the UHF band are used. For example, RFID tags having a size of 3×3 inches (about 75 mm×75 mm) are used as the labels. A size of a substrate of the RFID tag used as the substantially square label is equal to or smaller than a size of 3×3 inches, and a path length of a loop antenna disposed on the substrate corresponds to a wavelength of 0.8 times of a wavelength of an electric wave in the UHF band. Accordingly, when the size of the loop antenna is reduced, the path length cannot be substantially equal to a wavelength of the electric wave of the RFID tag in the UHF band. Further, the efficiency in the transmission and reception of the electric wave deteriorates. Therefore, there has been a problem in that a high gain is not obtained.

### SUMMARY

Embodiments of the present invention provide a loop antenna used in an RFID tag and the RFID tag.

According to an aspect of one or more embodiments of the invention, a loop antenna for an RFID tag includes an annular line member that includes one or more meandering parts, and a power feeding part that is provided on the line member. The annular line member includes the meandering parts at portions except for the vicinity of positions corresponding to loops of a standing wave occurring in the loop antenna.

According to this configuration, the entire path length of the antenna can be lengthened without increasing the size of the antenna. Therefore, it is possible to obtain a high gain antenna corresponding to a predetermined wavelength. In addition, since the meandering parts are provided at portions except for the vicinity of positions corresponding to loops of the standing wave occurring in the loop antenna, undesirable influence of the meandering parts on the gain can be suppressed. As a result, it is possible to obtain a high gain antenna corresponding to a predetermined wavelength.

In the loop antenna according to the aspect of one or more embodiments of the invention, the annular line member may include at least one of the meandering parts at positions corresponding to nodes of the standing wave occurring in the loop antenna.

According to this configuration, since the meandering parts are disposed at positions sufficiently spaced from the vicinity of the positions corresponding to the loops of the line member, undesirable influence of the meandering parts on the gain can be suppressed. As a result, it is possible to obtain a higher gain antenna corresponding to a predetermined wavelength.

According to another aspect of one or more embodiments of the invention, a loop antenna for an RFID tag includes an annular line member that includes one or more meandering parts, and a power feeding part that is provided on the line member. The annular line member includes the meandering parts thereon at portions except for the vicinity of a position where the power feeding part is provided and at portions except for the vicinity of a position where a path length from the power feeding part is half of an entire path length of the line member.

According to this configuration, the entire path length of the antenna can be lengthened without increasing the size of the antenna. Therefore, it is possible to obtain a high gain antenna corresponding to a predetermined wavelength. In addition, since the meandering parts are provided at portions except for the vicinity of positions corresponding to loops of the standing wave occurring in the loop antenna, undesirable influence of the meandering parts on the gain can be suppressed. As a result, it is possible to obtain a high gain antenna corresponding to a predetermined wavelength.

In the loop antenna according to another aspect of one or more embodiments of the invention, the annular line member may include at least one of the meandering parts at positions where the path length from the power feeding part is a quarter of the path length of the line member.

According to this configuration, since the meandering parts are disposed at positions sufficiently spaced from the vicinity of the positions corresponding to the loops of the line member, undesirable influence of the meandering parts on the gain can be suppressed. As a result, it is possible to obtain a higher gain antenna corresponding to a predetermined wavelength.

In the loop antenna according to the aspects of one or more embodiments of the invention, the annular line member may have a rectangular shape, and the annular line member may include at least one of the meandering parts on the sides thereof except for a side that includes the power feeding part and a side that faces the side including the power feeding part.

According to this configuration, an undesirable influence of the meandering parts on the side that corresponds to the loops and does not have the meandering parts can be suppressed. As a result, it is possible to obtain a high gain antenna.

The loop antenna according to the aspects of one or more embodiments of the invention may further include a matching circuit that is connected to the power feeding part.

According to this configuration, it is possible to obtain a high gain antenna.

According to another aspect of one or more embodiments of the invention, an RFID tag includes the above-described loop, an integrated circuit that is connected to the power feeding part, and a dielectric substrate on which the loop antenna is disposed.

According to this configuration, it is possible to obtain a high gain RFID tag.

Various implementations may include one or more the following advantages. For example, according to the loop antenna of the aspects of the invention, it is possible to provide a high gain loop antenna.

### BRIEF DESCRIPTION OF THE DRAWINGS

FIG. 1 is a plan view showing the configuration of an RFID tag according to a first embodiment of the invention.

FIG. 2 is a schematic view showing the configuration of the RFID tag according to the first embodiment of the invention.

FIG. 3 is a view showing a relationship between a loop antenna and a standing wave.

FIG. 4 is a view showing current distribution of the loop antenna.

FIG. 5 is a view showing results of a simulation.

FIG. 6 is a view showing the results of the simulation.

FIG. 7 is a view showing a modification of the RFID tag.

FIG. 8 is a view showing another modification of the RFID tag.

FIG. 9 is a view showing another modification of the RFID tag.

FIG. 10 is a view showing another modification of the RFID tag.,

### DETAILED DESCRIPTION

Hereinafter, embodiments of a loop antenna will be described with reference to the drawings. In addition, since elements having the same reference numerals perform the same operation in the embodiment, the description thereof will be omitted so as to avoid repeating the description.

### Embodiment

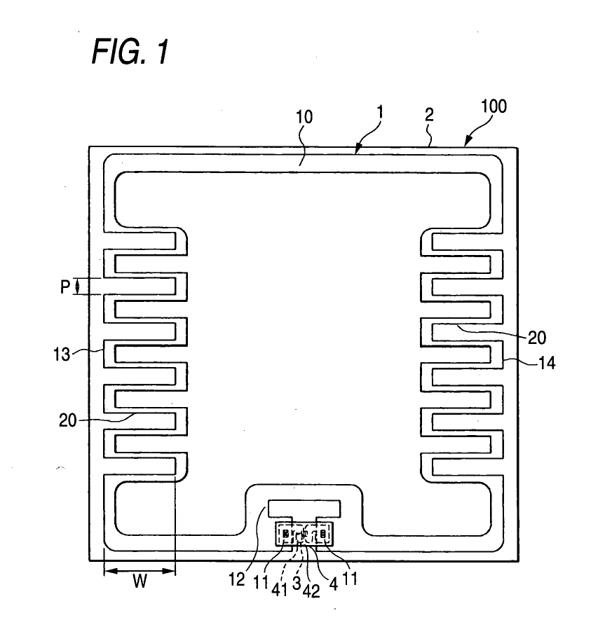

FIG. 1 is a plan view showing the configuration of an RFID tag according to this embodiment.

An RFID tag 100 includes an antenna 1, a dielectric substrate 2, an integrated circuit 3, and a strap 4. The antenna 1 includes a line member 10, power feeding parts 11, and a matching circuit 12. In addition, the line member 10 includes meandering parts 13 and 14.

The antenna 1 is used to transmit and receive an electric wave. Specifically, the antenna is a so-called loop antenna having an annular shape. The antenna may be made of any material as long as the antenna is made of conductor. In general, a filmy conductor, for example, metal is used as the antenna 1. However, the thickness of the conductor is not limited. Hereinafter, the antenna formed of aluminum that is rolled to have a thickness of about 15 μm will be described as an example of the antenna.

The line member 10 is a conductor having one or more meandering parts. For example, the line member 10 includes sides extending in a vertical direction, that is, two meandering parts 13 and 14 that are provided on left and right sides of the substrate, respectively. In this embodiment, the line member 10 has a rectangular-shaped plane surface along sides of the rectangular dielectric substrate 2. The shape of the plane surface of the line member 10 in plan view is not limited. However, preferably, the line member has a substantially square shape to serve as a loop antenna. In this embodiment, the line member 10 has a width of about 68 mm and a length of about 70 mm. Line widths of the sides not having the meandering parts 13 and 14 are in the range of about 2 to 4 mm, and line widths of the portions, except the meandering parts 13 and 14, of the sides having the meandering parts 13 and 14 are in the range of about 1 to 3 mm. Further, line widths of meandering sides in the meandering parts 13 and 14 are in the range of about 0.5 to 2 mm. However, the line width of the line member 10 is not limited to the above values. In addition, each of the line widths may not be uniform. Each of the corners of the bent portions in the line member 10 may be rounded as shown in FIG. 1, or not rounded. The shape of each corner is not limited. The annular shape described in this embodiment is limited to a continuous shape. For example, although having an annular shape, the line member 10 may be partially cut off at power feeding parts 11 to be described below. In this embodiment, as an example, the line member 10 is formed of aluminum that is rolled to have a thickness of about 15 μm. However, the thickness and the material of the line member are not limited. The meandering parts 13 and 14 included in the line member 10 will be described below.

The power feeding parts 11 are provided in the line member 10. Each of the power feeding parts 11 is used as a terminal that is formed of a conductor and used to input and output current between the other elements and the antenna 1. In this embodiment, the power feeding parts 11 are provided on one side of the rectangular line member. For example, the power feeding parts 11 are provided in the middle of one side of the rectangular line member 10. However, the power feeding parts 11 may be disposed at any position in the line member 10. The power feeding parts 11 are connected to the integrated circuit 3 so as to input and output current between the antenna 1 and the integrated circuit 3. Here, a slit is provided at the center of each power feeding part 11, and the integrated circuit 3 is connected to the centers of the power feeding parts 11 so that the integrated circuit 3 bridges the slit. The integrated circuit 3 is connected to the power feeding parts 11 through the strap 4. The shape of each power feeding part 11 is not limited. For example, although each of the power feeding parts 11 is formed of aluminum that is rolled to have a thickness of about 15 μm, the thickness and the material of each power feeding part are not limited.

The matching circuit 12 is a circuit that is connected with the power feeding parts 11 and matches the impedances of the antenna 1 and the integrated circuit 3. Here, an RFID tag provided with a so-called T-shaped matching circuit formed of a conductor will be described as an example of the RFID tag. The matching circuit 12 is formed integrally with other parts of the antenna 1. In addition, since the configuration of the matching circuit, such as a T-shaped matching circuit, is known to those in the art, the description thereof will be omitted. Further, when it is not necessary to match the impedances, that is, when the impedances are matched between the integrated circuit and the antenna, the matching circuit 12 may be omitted. The matching circuit 12 is formed on the line member 10 to reduce the size of the antenna 1.

The meandering parts 13 and 14 are portions that have a meandering shape of the line member 10. The meandering parts 13 and 14 are a pair of linear portions that are formed of conductors and connected to the power feeding parts 11, respectively. Further, the pair of linear portions of the meandering parts 13 and 14 extends from the centers of power feeding parts 11 toward the ends of the power feeding parts 11, respectively. The meandering parts 13 and 14 are formed on the annular line member 10 at the portions except for the vicinity of positions corresponding to loops of the standing wave occurring in the loop antenna 1. The loops are portions where the standing wave has a maximum amplitude. That is, the meandering parts 13 and 14 are formed on the annular line member 10 at portions except for the vicinity of positions of where the power feeding parts 11 are provided, and at portions except for the vicinity of a position of where a path length from the power feeding part 11 is half of an entire path length of the line member 10. Further, the vicinity of the above positions indicates positions not adjacent to each of the positions. At least one of the meandering parts 13 and 14, preferably, all the meandering parts are preferably formed on the annular line member 10 at portions corresponding to nodes of the standing wave occurring in the loop antenna 1. The nodes are portions where the standing wave has a minimum amplitude. That is, at least one of the meandering parts 13 and 14, preferably, all the meandering parts 13 and 14 are preferably formed on the annular line member 10 at portions where the path length from the power feeding part 11 is a quarter of the entire path length of the line member 10. “At portions corresponding to nodes” and “at portions where the path length from the power feeding part is a quarter of the entire path length” means that “a part of the meandering parts is positioned at portions corresponding to nodes” and “a part of the meandering parts is positioned at portions where the path length from the power feeding part is a quarter of the entire path length”. In addition, when the loop antenna 1 has a rectangular shape, the meandering parts 13 and 14 are preferably formed on the sides of the line member except for the side having the power feeding parts and the side facing the side that has the power feeding parts. In particular, the meandering parts 13 and 14 are provided on the left and the right sides, respectively, of the annular line member 10 so that the centers in the extension direction of the meandering parts 13 and 14 are positioned at the portions corresponding to the nodes of the standing wave occurring in the loop antenna 1. That is, the meandering parts 13 and 14 are provided on the left and the right sides, respectively, of the annular line member 10 so that the centers in the extension direction of the meandering parts 13 and 14 are positioned on the annular line member 10 at the portions where the path length from the power feeding part 11 is a quarter of the entire path length of the line member 10. Even though including two meandering parts 13 and 14 in this embodiment, the line member 10 may include one or more meandering parts. For example, three or more meandering parts shorter than the meandering parts 13 and 14 in the vertical direction, that is, in the extension direction of the meandering parts may be provided to the line member. However, it is preferable that meandering parts be symmetrically provided on the left and the right sides. Each of the meandering parts 13 and 14 described herein include a structure called a meander-line. The “meandering” described herein indicates a state so as to extend to the right and left sides in an alternately curved shape. The starting directions of the meandering parts 13 and 14 are not limited. In addition, the meandering parts 13 and 14 may be symmetrical or not symmetrical. Curved portions of the meandering parts 13 and 14 may have rounded corners or rectangular corners, and the shape of the curved portion is not limited. In addition, each of the meandering parts 13 and 14 is formed of a meandering linear conductor, and includes a plurality of sides that are formed of the meandering linear conductors and arranged in the extension direction of the meandering parts 13 and 14. In addition, the sizes of the line member 10 of the meandering parts 13 and 14 are not limited, and may not be uniform. In this embodiment, the meandering parts 13 and 14 are symmetrical as an example of the meandering parts, and each of the sides of the meandering parts 13 and 14 extends in a direction orthogonal to the left and the right sides of the line member 10. A distance (hereinafter, referred to as a meandering gap) P between the sides is about 3 mm, and the lengths (hereinafter, referred to as a meandering width) W in a transverse direction of a plurality of recesses 20 formed in the meandering parts 13 and 14 by meandering of the line member 10 is in the range of about 12 to 17 mm. Furthermore, the number of bending the meandering parts 13 and 14, that is, the number of bent portions formed by bending the meandering parts is eleven for each meandering part. However, the number of the bent portions is not limited. The number of the bent portions is adequately set in accordance with the meandering gap or the meandering width, the line width of the line member 10 at the meandering parts 13 and 14, and the size of the entire antenna 1 so that the entire path length of the line member 10 is equal to a wavelength to be used. The meandering parts 13 and 14 protrude from the portions, which do not have the meandering parts 13 and 14, of the left and the right sides of the line member 10 only toward the inside of the line member 10. For this reason, the antenna 1 can be set to have the same size as the line member 10 that does not have the meandering parts 13 and 14. Therefore, it is possible to prevent an increase in the size of the antenna 1.

The dielectric substrate 2 is used to dispose and fix the antenna 1 thereon. In addition, the dielectric substrate 2 is used to dispose and fix the integrated circuit 3 or a strap 4 thereon. For example, here, the antenna 1 is attached on the surface of the dielectric substrate 2 by an adhesive. Further, the strap 4 is pressed against and bonded to the dielectric substrate 2 at a position corresponding to the power feeding parts 11 so that wiring lines provided on the surface of the strap 4 are connected to the power feeding parts 11. The dielectric substrate 2 is formed of a dielectric material, such as polyethylene terephthalate (PET) or epoxy resin. The thickness of the dielectric substrate 2 is not limited. However, when the dielectric substrate 2 is used as an RFID tag 100 that is used in an IC card or a luggage label, it is preferable that the dielectric substrate be thin and flexible. Here, a transparent PET film having a thickness of about 38 μm is used as an example of the dielectric substrate 2. In general, the size of the dielectric substrate 2 defines the size of the RFID tag. The dielectric substrate 2 has a rectangular shape, specifically, a substantially square shape in this embodiment. However, the shape of the dielectric substrate 2 in plan view is not limited. For example, the size of the dielectric substrate 2 is equal to or smaller than the size of the label commonly used in an American distribution industry, that is, the size of about 3×3 inches. However, the size of the dielectric substrate 2 is not limited.

The integrated circuit 3 is connected to the power feeding parts 11. The integrated circuit 3 has a function of a transceiver that transmits and receives discriminating information through the antenna 1. In addition, the integrated circuit 3 is operated by the current that is fed from the antenna 1 through the power feeding parts 11. Any integrated circuit that is used as an integrated circuit of a common RFID tag may be used as the integrated circuit 3, and the detailed description thereof will be omitted herein. The thickness of the integrated circuit 3 is not limited. According to this embodiment, the integrated circuit 3 is interposed between the surface of the strap 4 and the surface of the dielectric substrate 2 in a space between the power feeding parts 11. Accordingly, it is preferable that the integrated circuit has a size capable of being disposed in the space. Since the dielectric substrate 2 and a dielectric substrate 42 of the strap 4 are flexible, it is possible to dispose the integrated circuit 3 having a large thickness than the antenna 1, for example, the integrated circuit 3 having a thickness of about 150 to 180 μm in the space.

The strap 4 is a member that is used to connect the integrated circuit 3 to the power feeding parts 11 of the antenna 1 and to fix the integrated circuit 3 to the dielectric substrate 2. The strap 4 has the same configuration as the antenna 1 and the dielectric substrate 2, except for the size thereof. A filmy wiring line 41 is provided on the surface of the dielectric substrate 42 for the strap, and the integrated circuit 3 is bonded on the surface of the strap 4 so as to be connected to the wiring line 41. The dielectric substrate 42 has, for example, a thickness of about 25 μm, a length of about 4 mm, and a width of about 9 mm. In this embodiment, the wiring line has, for example, a thickness of about 35 μm, a length of about 3 mm, and a width of about 8 mm. The wiring line 41 is formed using the same method as the antenna 1. For example, the integrated circuit 3 is bonded to the wiring line 41 with solder or a conductive adhesive. A method of bonding the integrated circuit 3 is not limited. The strap 4 is connected to the antenna 1 and the dielectric substrate 2 so that the wiring line 41 is connected to the power feeding parts 11 on the dielectric substrate 2. In this embodiment, the surface of the strap 4 is attached to the surface of the dielectric substrate 2 so as to face the surface of the dielectric substrate 2. As a result, the integrated circuit 3 is interposed between the strap 4 and the dielectric substrate 2 in the space formed in the power feeding parts 11. For example, the strap 4 includes an electrode (not shown), which is connected to the wiring line 41, on the surface thereof as disclosed in U.S. Pat. No. 6,664,645. The surface of the strap is disposed to face the surface, on which a hot melt adhesive is applied, of the dielectric substrate 2, that is, the surface on which the antenna 1 or the like is provided. Then, while an ultrasonic wave is applied, the strap 4 and the dielectric substrate 2 are pressed against each other. Therefore, the antenna 1 and the dielectric substrate 2 are bonded to each other so that the electrode and the power feeding parts 11 provided on the rear surface of the dielectric substrate 2 are connected to each other. As a result, the power feeding parts 11 and the integrated circuit 3 are connected to each other. However, a method of bonding the strap 4 is not limited. In addition, as long as the integrated circuit 3 is electrically connected to the power feeding parts 11, any method may be used to connect the integrated circuit 3 with the power feeding parts 11. For example, as shown in FIG. 1, the integrated circuit 3 does not need to be connected to the power feeding parts 11 through the strap 4, that is, the power feeding parts 11 may be directly connected to the integrated circuit 3 without the strap 4.

For example, after rolled aluminum is bonded on the rear surface of the dielectric substrate 2 so as to form an aluminum layer on the rear surface of the dielectric substrate 2, a mask is formed on the aluminum layer by gravure or photolithography printing. Subsequently, the mask is used as an etch mask, and then the dielectric substrate is etched by acid or alkali to form the antenna 1 of the RFID tag 100. However, a method of forming the antenna 1 is not limited. For example, the shape of the antenna 1 may be printed on the dielectric substrate 2 by using metal ink to form the antenna 1. Meanwhile, since the method of forming the antenna 1 is well known, the description thereof will be omitted in this specification.

Next, the operation of the RFID tag 100 will be briefly described below. When, a carrier wave radiated from an RFID reader-writer (not shown) reaches the antenna 1, power obtained by the antenna from the carrier wave is supplied to the integrated circuit 3 through the strap 4. The integrated circuit 3 operates on the basis of signals included in the carrier wave, for example, reads the discriminating information from a memory, by means of the supplied power. The carrier wave received from the RFID reader-writer is used as a wave source so that the information obtained as a result of the operation is transmitted through the antenna 1.

As described in the Related Art, when the linear loop antenna is disposed in the RFID tag 100 along the sides of the dielectric substrate, the path length of the antenna to be disposed is limited by the size of the dielectric substrate. Accordingly, when the size of the dielectric substrate is reduced, it is not possible to ensure a path length corresponding to an electric wave in a desired wavelength range, specifically, a path length corresponding to a wavelength of the electric wave. In addition, the antenna cannot efficiently radiate and absorb the electric wave in the desired wavelength range. That is, it is not possible to increase a gain. In particular, when the RFID tag having a size of 3×3 inches is used in a UHF band, it is possible to ensure the path length of the loop antenna corresponding to a wavelength of only 0.8 times of the wavelength of the electric wave in the UHF band. Therefore, it is not possible to obtain a high gain.

For this reason, the meandering parts 13 and 14 are provided on the line member 10 in this embodiment. The meandering parts 13 and 14 can be formed so that the length of the path through which current flows is longer than the lengths of the meandering parts 13 and 14 in the extension direction thereof. For this reason, when the meandering parts 13 and 14 are provided on the line member 10, the entire path length of the line member 10 disposed on the dielectric substrate 2 is simply lengthened as compared to when the linear loop antenna is disposed in the RFID tag 100 along the sides of the dielectric substrate. Accordingly, it is possible to ensure the path length of the loop antenna corresponding to an electric wave in a desired wavelength band, that is, in the UHF band.

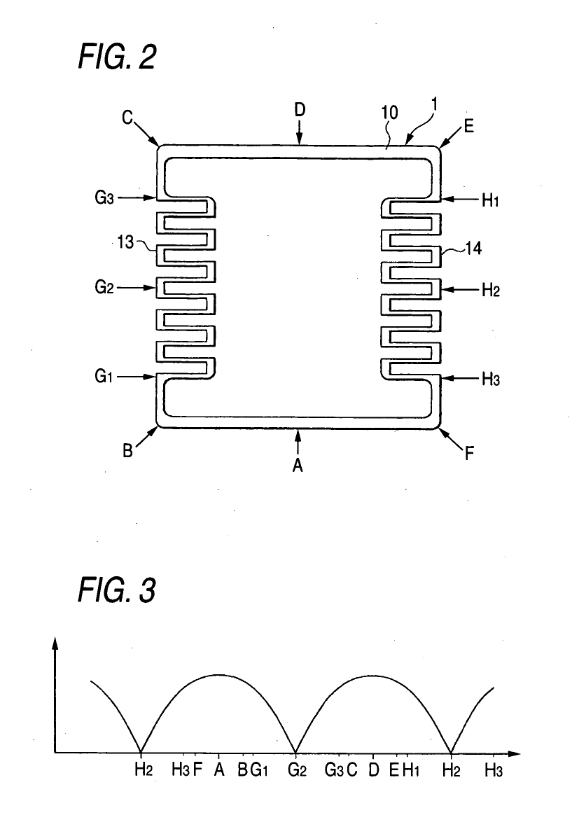

FIG. 2 is a view showing the configuration of the RFID tag. The same reference numerals as those in FIG. 1 are given to the same elements or corresponding portions in FIG. 2. Here, the meandering parts 13 and 14 are provided on the line member 10 so that the path length of the antenna 1 is adjusted to be equal to λ. The λ is a wavelength of an electric wave received by the antenna 1. Position A is a position where the power feeding parts 11 are disposed, and position D is a position where the path length is half of the entire path length of the line member 10. Further, each of positions G₂ and H₂ is a position where the path length is a quarter of the entire path length of the line member 10, and positions B, C, E, and F are positions corresponding to corners of the rectangular line member 10. Furthermore, positions G₁ and G₃ are positions corresponding to both ends of the meandering part 13, and positions H₁ and H₃ are positions corresponding to both ends of the meandering part 14. In FIG. 2, when each of the path lengths between F and B positions and between C and E positions is represented as x and each of the path lengths between the B and C positions and between the E and F positions is represented as y, the entire path length of the line member 10 satisfies relationships “2x+2y=λ and “x+y=λ/2”. In this case, the path lengths of the meandering parts 13 and 14 are equal to each other, and the positions G₂ and H₂ are the middles of the path lengths of the meandering parts 13 and 14, respectively. In addition, when the position A is positioned between the position B and the position F, the path length between the position C and the position, D satisfies a relationship “λ−x/2−y=x/2” and the position D is positioned between the position C and the position E. Further, the path between the position F and the position B indicates a path that passes through the position A and is positioned between the position F and the position B.

FIG. 3 is a schematic view showing a relationship between the path length and the standing wave of the loop antenna 1. In FIG. 3, a vertical axis represents amplitude of the standing wave occurring in the antenna 1, and a horizontal axis represents the respective positions in the antenna 1 shown in FIG. 2. Distances between the respective positions shown in FIG. 3 correspond to the path lengths between the respective positions shown in FIG. 2. For convenience sake, the ratios of the path lengths between the respective positions on the horizontal axis of FIG. 3 do not accurately reflect the ratios of the actual path lengths between the respective positions of the antenna 1.

As shown in FIG. 3, when the path length of the antenna 1 is substantially equal to a wavelength λ of the electric wave received by the antenna 1, the portion corresponding to the power feeding part 11 and the portion where the path length from the power feeding part 11 is half of the entire path length, that is, λ/2, are portions corresponding to the loops of the standing wave. Since the portions corresponding to the loops of the standing wave have maximum current, the antenna has maximum operation efficiency in the vicinity of the above portions.

Meanwhile, the line member 10 meanders at the meandering parts 13 and 14. For this reason, reversed current flows between the sides of the line member that are bent so as to be adjacent to each other, whereby electrostatic coupling occurs between the sides. As a result, current loss occurs. When the meandering parts 13 and 14 having large current loss are provided to the portions having high current, the current loss increases and the amplitude of the portion of the antenna having maximum operation efficiency is disturbed. As a result, the gain of the antenna 1 decreases.

For this reason, according to this embodiment, the meandering parts 13 and 14 are provided to the antenna 1 at the positions except for the vicinity of positions corresponding to the loops of the standing wave, that is, on the line member 10 at the positions except for the vicinity of the positions of where the power feeding parts 11 are provided, and at the positions except for the vicinity of the positions where the path length from the power feeding part 11 is half of the entire path length of the line member 10. Therefore, the influence of the meandering parts 13 and 14 on the portions of the antenna 1 that have maximum current and maximum operation efficiency can be suppressed. As a result, it is possible to maintain a high gain of the antenna 1.

Furthermore, according to this embodiment, the meandering parts 13 and 14 are provided to the antenna 1 at the positions, which have minimum current, corresponding to the nodes of the standing wave, that is, on the line member 10 at the positions where the path length from the power feeding part 11 is a quarter of the entire path length of the line member 10, that is, so as to pass through the positions where the path length from the power feeding part is a quarter of the path length of the line member 10. As a result, the meandering parts 13 and 14 are provided in the vicinity of the nodes, that is, the portions that have minimum power of the standing wave. According to this configuration, it is possible to reduce the current loss caused by the meandering parts 13 and 14. In addition, the meandering parts 13 and 14 are disposed at the portions of the antenna that have excellent operation efficiency, that is, at the positions spaced from the vicinity of the portions corresponding to the loops of the standing wave. Therefore, the influence of the meandering parts 13 and 14 on the antenna 1 can be suppressed. As a result, it is possible to increase the gain of the antenna 1.

Furthermore, according to this embodiment, the meandering parts 13 and 14 are provided to the antenna 1 so that the respective middles G₂ and H₂ of the path lengths of the meandering parts 13 and 14 are positioned at the positions, which have minimum current, corresponding to the nodes of the standing wave, that is, on the line member 10 at the positions where the path length from the power feeding part 11 is a quarter of the path length of the line member 10. As a result, the meandering parts 13 and 14 are provided on both sides of the nodes, that is, the portions that have minimum power of the standing wave. Accordingly, it is possible to minimize the current loss caused by the meandering parts 13 and 14. Furthermore, the meandering parts 13 and 14 are disposed at the positions farthest from any one of the positions A and D, where the antenna has maximum operation efficiency and two loops of the standing wave occur, so that the distance between the position A and the position G₁ is equal to the distance between the position D and the position G₃ and the distance between the position A and the position H₃ is equal to the distance between the position D and the position H₁, in FIG. 3. As a result, the influence of the meandering parts 13 and 14 on the antenna 1 can be minimized, thereby further increasing the gain of the antenna 1.

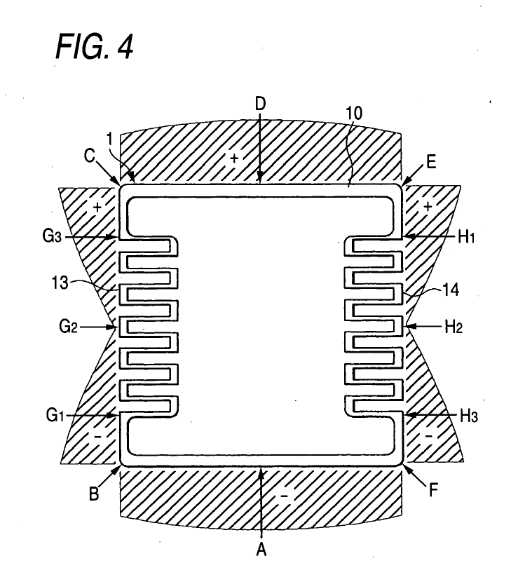

FIG. 4 is a schematic view showing current distribution of the antenna 1 shown in FIG. 2. In FIG. 4, hatched portions indicate the current distribution and the current distribution along the line member 10. The amplitudes of the hatched portions are represented as heights in a direction orthogonal to the sides of the line member 10.

In FIG. 4, if current flows in the antenna 1 in a clockwise direction, reversed current flows between the position C and the position E and between the position F and the position B. However, since a sign of the current flowing between the position F and the position B is negative, a current vector between the position F and the position B is equal to a current vector between the position C and the position E.

Meanwhile, a sign of current flowing between the position B and the position C is reversed at the middle position G₂, and a sign of current flowing between the position E and the position F is reversed at the middle position H₂. In addition, the current flowing between the position B and the position C flows upward, and the current flowing between the position E and the position F flows downward. Accordingly, the current flowing directions are opposite to each other. Therefore, current vectors of the sides are opposite to each other between an upper side and a lower side of the line member and between a left side and a right side of the line member.

Since an electric field radiated from the antenna 1 is mainly defined by current having a large amplitude, the radiation electric field of the antenna 1 is defined by the radiation from the side between the position F and the position B and between the position C and the position E. Further, the radiation electric field of the antenna has the same characteristic as two dipole antennas parallel to the transverse direction of the in-phase power feeding.

Meanwhile, the current flowing in two sides between the position B and the position C extending in the vertical direction, and between the position E and the position F extending in the vertical direction has small amplitudes and phases opposite to each other. Therefore, the influence on the radiation electric field is also small.

According to this embodiment, in particular, since the meandering parts 13 and 14 are provided on the side orthogonal to the side having the power feeding parts 11, the meandering parts 13 and 14 are provided at positions where the influence on the radiation electric field is small. Therefore, it is possible to suppress the influence of the meandering parts 13 and 14 on the radiation electric field of the antenna 1, and to increase the gain of the antenna.

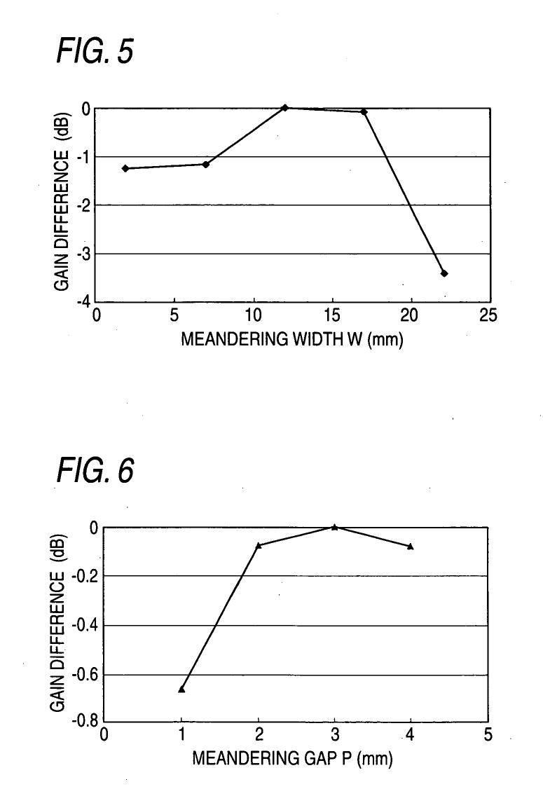

FIG. 5 is a view showing simulation results that show a relationship between a meandering width W and a gain difference of the antenna 1 according to this embodiment. The gain difference to be described herein is a relative gain of the antenna 1 with respect to the meandering width W in case that the absolute gain of the antenna 1 is set to zero when the highest gain is obtained by adjusting the meandering width W.

As shown in FIG. 5, when the meandering width W of the antenna 1 is changed, the gain difference is changed. According to the results, it is understood that the gain difference of the antenna 1 is small and the radiation efficiency of the antenna 1 is most excellent when the meandering width W is in the range of about 12 to 17 mm.

FIG. 6 is a view showing simulation results that show a relationship between a meandering gap P and a gain difference of the antenna 1 according to this embodiment.

As shown in FIG. 6, when the meandering gap P of the antenna 1 is changed, the gain difference is changed. According to the results, it is understood that the gain difference of the antenna 1 is small and the radiation efficiency of the antenna 1 is most excellent when the meandering gap P is about 3 mm.

According to the above results, when the meandering parts 13 and 14 having the meandering width W in the range of about 12 to 17 mm and the meandering gap P of about 3 mm are provided to the line member, it is possible to obtain a loop antenna having high gain difference and excellent radiation efficiency.

According to the above-described embodiment, when the meandering parts 13 and 14 are provided to the line member 10, the entire path length of the antenna 1 can be lengthened without increasing the size of the antenna 1. Therefore, it is possible to obtain a high gain antenna corresponding to a predetermined wavelength. In addition, the meandering parts 13 and 14 are provided on the line member 10 at the portions except for the vicinity of the positions corresponding to loops, in particular, at the portions corresponding to nodes. Accordingly, undesirable influence of the meandering parts 13 and 14 on the gain can be suppressed. As a result, it is possible to obtain a high gain antenna corresponding to a predetermined wavelength.

In addition, according to this embodiment, two meandering parts 13 and 14 are provided at the portions corresponding to the nodes. However, at least one of a plurality of meandering parts may be provided at the portion corresponding to the node. According to this configuration, undesirable influence of the meandering parts on the antenna can be reduced compared to when all of the plurality of meandering parts is not provided at the position corresponding to the node. As a result, it is possible to increase the gain of the antenna 1.

Further, according to the first embodiment, the power feeding part 11 is provided in the middle of one side of the rectangular line member 10. However, the RFID tag according to this embodiment, the poser feeding part 11 may be positioned at any position on the line member 10.

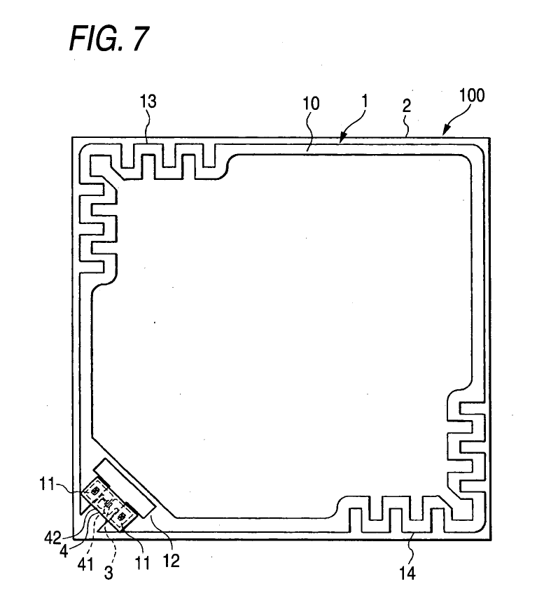

For example, according to a first modification shown in FIG. 7, the power feeding parts 11 may be provided at the corner of the line member 10. Even in this case, as shown in FIG. 7, the meandering parts 13 and 14 are provided on the line member 10 at the portions except for the vicinity of the positions corresponding to loops, in particular, at the portions corresponding to nodes. That is, the meandering parts 13 and 14 are provided on the line member 10 at the positions except for the vicinity of the positions where the power feeding parts 11 are provided, and at the positions except for the vicinity of the positions where the path length from the power feeding part 11 is half of the entire path length of the line member 10, in particular, at the positions where the path length from the power feeding part is a quarter of the path length of the line member 10. Therefore, undesirable influence of the meandering parts on the gain can be suppressed. As a result, it is possible to increase the gain of the antenna 1. As a result, it is possible to obtain a high gain antenna corresponding to a predetermined wavelength.

Further, two meandering parts 13 and 14 are provided in this embodiment. However, if all the meandering parts are not provided in the vicinity of the positions corresponding to the nodes of the standing wave, the number of the meandering parts may be one or more.

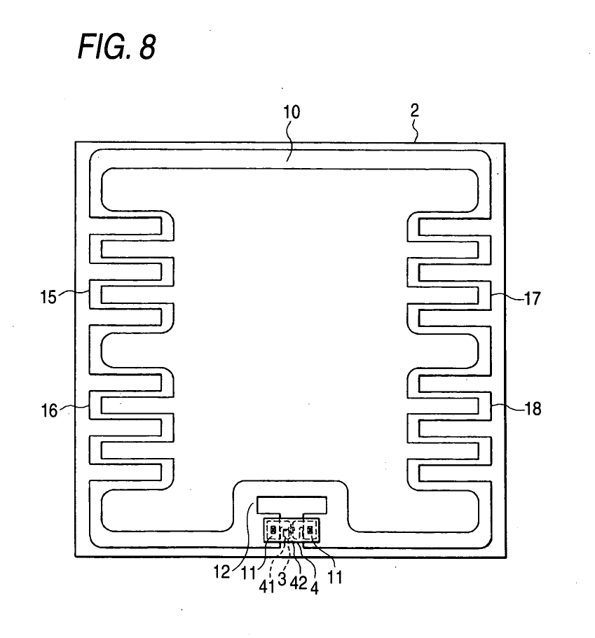

For example, according to a second modification shown in FIG. 8, the meandering parts 13 and 14 are not provided on the line member 10, and four meandering parts 15 to 18 may be provided on sides of the antenna 1 extending in a vertical direction. According to this configuration, the path length can be lengthened without increasing the size of the antenna 1, and undesirable influence of the meandering parts on the gain can be suppressed. As a result, it is possible to obtain a high gain antenna corresponding to a predetermined wavelength.

Furthermore, in this embodiment, the number of bent portions of the meandering parts is eleven for each meandering part. However, in the invention, the total number of bending each meandering part and bending all the meandering parts of the line member 10 is not limited.

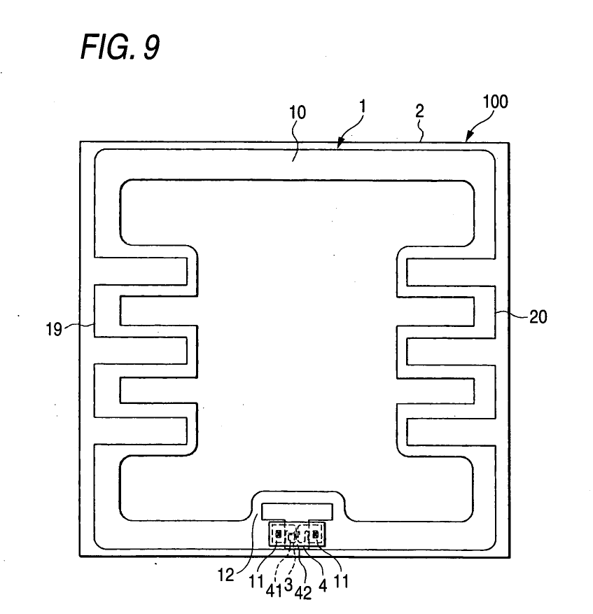

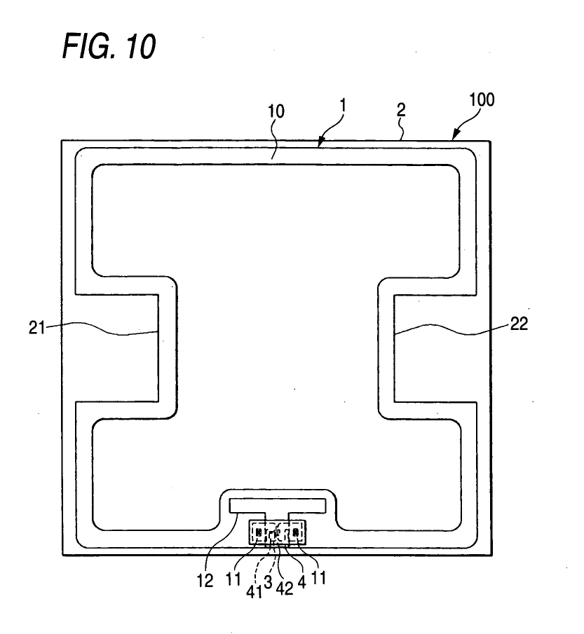

For example, in the antenna 1 shown in FIG. 1, the meandering parts 19 and 20 where the number of bending each meandering part is five as shown in FIG. 9 may be provided instead of the meandering parts 13 and 14. In addition, as shown in FIG. 10, meandering parts 21 and 22 where the number of bending each meandering part is one may be provided. Even in this case, it is possible to obtain a high gain antenna similar to that in FIG. 1. In this case, a meandering gap P and a meandering width W of the meandering parts 19 to 22, and a line width of the line member 10 at the meandering parts is adequately adjusted in accordance with the wavelength of the electric wave used in the antenna 1.

The invention is not limited to the embodiment described above, and has various modifications. It should be understood that the various modifications are included in the scope of the invention.

As described above, the loop antenna according to the embodiment of the invention is used as an antenna for a small RFID tag, in particular, as an antenna for an RFID tag for UHF band.

What is claimed is:

1. A loop antenna for an RFID tag, comprising:
an annular line member that includes one or more meandering parts; and
a power feeding part provided on the line member,
wherein the annular line member includes the meandering parts at portions except for the vicinity of positions corresponding to loops of a standing wave occurring in the loop antenna.

2. The loop antenna according to claim 1,
wherein the annular line member includes at least one of the meandering parts at positions corresponding to nodes of the standing wave occurring in the loop antenna.

3. A loop antenna for an RFID tag, comprising:
an annular line member that includes one or more meandering parts; and
a power feeding part provided on the line member,
wherein the annular line member includes the meandering parts thereon at portions except for the vicinity of a position where the power feeding part is provided and at portions except for the vicinity of a position where a path length from the power feeding part is half of an entire path length of the line member.

4. The loop antenna according to claim 3,
wherein the annular line member includes at least one of the meandering parts at positions where the path length from the power feeding part is a quarter of the path length of the line member.

5. The loop antenna according to claim 1,
wherein the annular line member has a rectangular shape, and
the annular line member includes at least one of the meandering parts on the sides thereof except for a side that includes the power feeding part and a side that faces the side including the power feeding part.

6. The loop antenna according to claim 1, further comprising:
a matching circuit that is connected to the power feeding part.

7. An RFID tag comprising:
the loop antenna according to claim 1;
an integrated circuit that is connected to the power feeding part; and
a dielectric substrate on which the loop antenna is disposed.
